(19) United States
(12) Patent Application Publication
(10) Pub. No.: US 2010/0153342 A1
(43) Pub. Date: Jun. 17, 2010

(54) VIM NEXT GENERATION - MIGRATION

(76) Inventor: Alistair DUNCAN, Danville, CA (US)

Correspondence Address: Visa USA c/o Duane Morris LLP;Attn: James Sze, Esq., 101 West Broadway, Suite 900, San Diego, CA, 92101, US

(21) Appl. No.: 12/337,071

(22) Filed: Dec. 17, 2008

(51) Int. Cl. G06F 17/30

(52) U.S. Cl. 707/661; 707/E17.007

(57) ABSTRACT

A method of transferring user records from a first system to a second system is disclosed. The method includes determining that a user record is eligible for migration from a first system to a second system. Establishing a connection between the first system and the second system. Transferring the user records from the first system to the second system, and flagging the user records has having been transferred.

### FIELD OF DISCLOSURE

The disclosure relates to transferring data. More specifically, the disclosure relates to transferring user data from a first application to a second application.

### BACKGROUND

A variety of online network services use specialized systems for user identification (“ID”) and password management. These user IDs and passwords are provided to prevent unauthorized access to the services. While the registered usernames are typically stored in an unencrypted form in a system's database, the passwords are stored in an encrypted form for security purposes.

In some instances a company or organization may migrate from one service to another. For example, a company may want to migrate from an Oracle based system to an Ariba based system or vice versa. In these instances, the migration from one system to a second system typically requires each user to re-register with the new system, the mass-distribution of temporary passwords and usernames, or for users to answer predetermined questions about themselves to register with the new system, because the encrypted passwords cannot be decrypted by the new service. Regardless of the method of registration that is employed, the registration is complex and costly to administer. Additionally, these conventional methods of migrating from one service to another service require an entire organization or group to be moved at the same time.

### SUMMARY

In some embodiments, a method of transferring user records from a first system includes determining that a user record is eligible for migration from a first system to a second system. Establishing a connection between the first system and the second system. Transferring the user records from the first system to the second system, and flagging the user records has having been transferred.

In some embodiments, a method includes identifying data associated with a plurality of users stored in a database as eligible for migration from a first network-based system to a second network-based system. The method further includes migrating the data from the first network-based system to the second network-based system, and setting an indicator in the data associated with each of the plurality of users that the data was transferred. The migration of data includes establishing a connection between the first network-based system and the second network-based system, and transferring data from the first network-based system to the second network-based system by way of the connection.

In some embodiments, a machine readable storage medium is encoded with program code that, when executed by a processor, the processor performs a method. The method includes establishing a connection between the first system and the second system. Transferring the user records from the first system to the second system, and flagging the user records has having been transferred by setting a flag in a database.

### BRIEF DESCRIPTION OF THE DRAWINGS

FIG. 1 is a block diagram of one example of a network-based system architecture.

FIG. 2 is a block diagram of one example of an architecture of a server configured to provide a network-based system illustrated in FIG. 1.

FIG. 3 is a block diagram illustrating an application database in accordance with the embodiment illustrated in FIG. 1.

FIG. 4 is a flow chart of a method of migrating data a first system to a second system in accordance with the disclosure.

### DETAILED DESCRIPTION

The disclosed method and its various implementations and variations thereof enable the migration of users from one system to another. Additionally, the disclosed method also enables user data to be migrated in stages without the increased complexity and cost associated with conventional systems.

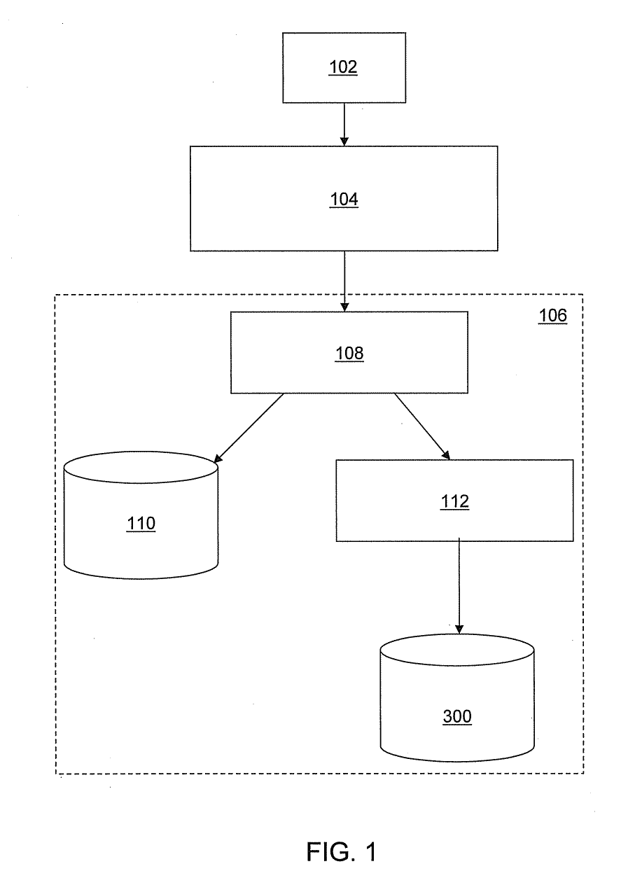

FIG. 1 illustrates one example of an architecture of a network-based system 106. The network-based system 106 may be any computer or network based system or application to which a user may gain access by way of a browser interface on a computer coupled to a network.

Examples of such systems include, but are not limited to, database management systems designed and operated by Oracle, Ariba, and the like. As shown in FIG. 1, in one example, a web-based system 106 is accessible to a user through the Internet 104. The user may connect to the Internet 104 through a computer 102 or any other web-enabled device, such as, for example, a mobile phone, personal digital assistant (PDA), laptop computer, or the like.

In some embodiments, the user accesses the system 106 using a web browser, such as Internet Explorer by Microsoft Corp. of Redmond, Wash. or Firefox, by Mozilla Corporation of Mountain View, Calif., or the like. In some embodiments, the browser is used to access the system over a local area network (LAN), a campus network, or a wide area network (WAN). In some embodiments, the user accesses the system by way of a proprietary network. In other embodiments, the user accesses the system 106 over the Internet 104, using the worldwide web.

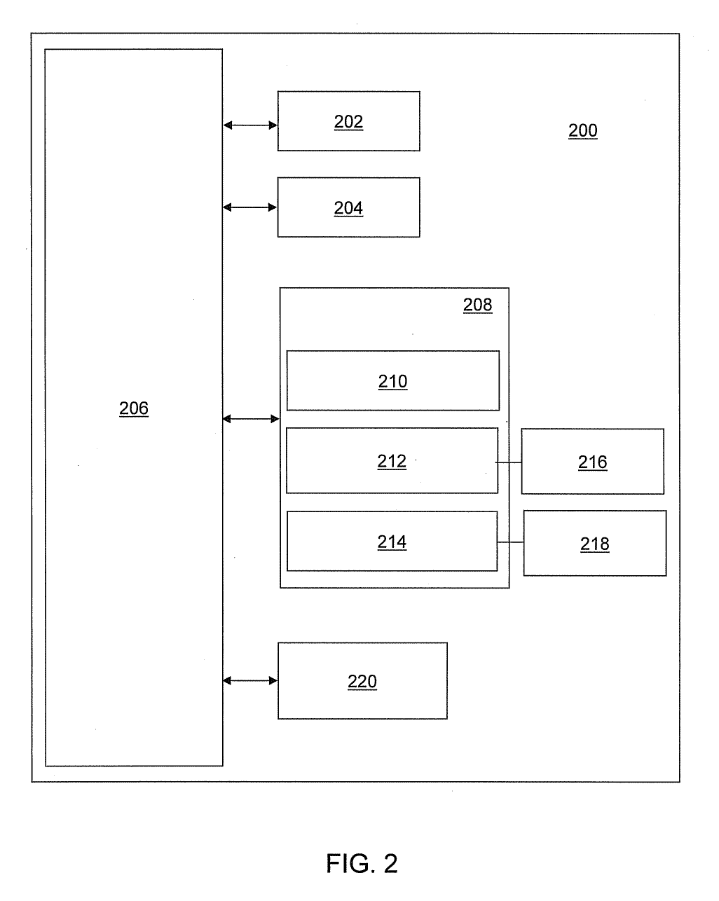

Network-based system 106 may be implemented in one or more servers 200. An example of such a server 200 is illustrated in FIG. 2. As shown in FIG. 2, server 200 may include one or more processors 202, which may be connected to a wired or wireless communication infrastructure 206 (e.g., a communications bus, cross-over bar, local area network (LAN), or wide area network (WAN)). Server 200 may include a main memory 204, such as a random access memory (RAM). Server 200 may also include a secondary memory 208 such as, for example, a hard disk drive 210 and/or removable storage drive 212, representing a floppy disk drive, a magnetic tape drive, an optical disk drive, or the like. The removable storage drive 212 may read from and/or write to a removable storage unit 216. Removable storage unit 216 may be a floppy disk, magnetic tape, CD-ROM, DVD-ROM, optical disk, ZIP™ drive, and the like, which may written to and/or read by removable storage drive 212. Removable storage unit 212 may include a machine readable storage medium 216 having stored therein computer software and/or data.

In some embodiments, secondary memory 208 may include other similar devices for allowing computer programs or other instructions to be loaded into server 200 such as a removable storage unit 218 and an interface 214. An example of such a device 218 and socket 214 includes, but is not limited to, a USB flash drive and associated USB port, respectively. Other removable storage units 218 and interfaces 214 that allow software and data to be transferred from the removable storage unit 218 to server 200 may be used.

Server 200 may also include a communications interface 220. Communications interface 220 allows software and data to be transferred between server 200 and external devices, such as computer 102 shown in FIG. 1. Examples of communications interface 220 may include a modem, a network interface (such as an Ethernet card), a communications port, a Personal Computer Memory Card International Association (PCMCIA) slot and card, or the like. Software and data transferred via communications interface 220 are in the form of signals which may be electronic, electromagnetic, optical, or any other signal capable of being received by communications interface 220. These signals are provided to communications interface 220 via a communications path or channel. The path or channel that carries the signals may be implemented using wire or cable, fiber optics, a telephone line, a cellular link, a radio frequency (RF) link, and the like.

Referring again to FIG. 1, network-based system 106 includes a user login portal 108 that is configured to compare login information entered by a user with data stored in a user login database 110 prior to allowing the user to gain access to the network-based system 106. For example, a user may be required to enter a username and a password at login portal 108, and the information entered by the user may be compared with information stored in the user login database 110. User login database 110 may be disposed within the main memory 204 or the secondary memory 208 of a server 200. In some embodiments, the password is stored in an encrypted form and is associated with an unencrypted username.

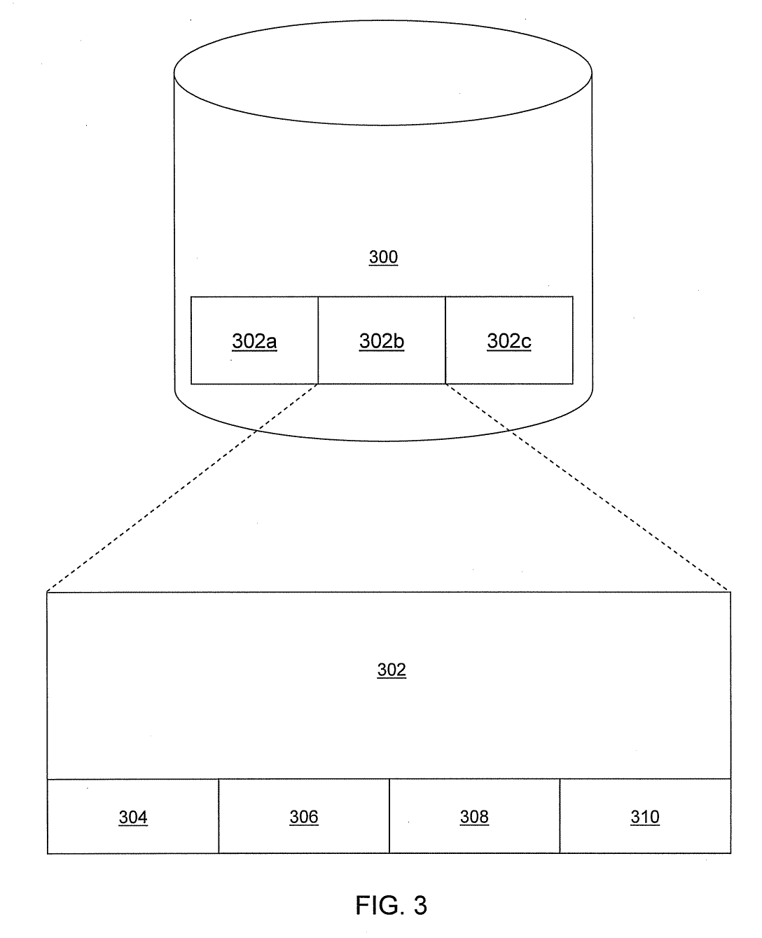

Network-based system 106 may also include a network application interface 112 through which a user may operate and perform functions of the network-based system 106. The network application interface may be connected to application database 114, which may store network-based applications as well as user-specific application data. FIG. 3 illustrates one example of an application database 114. As shown in FIG. 3, application database 300 may include one or more user data records 302a, 302b, 302c. The user data may include a user identification, an address, a list of privileges within the system, or any other data record that may be stored in a database.

In some embodiments, each user data record 302 may also include one or more indicators or flags 304, 306, 308, 310. The flags 304, 306, 308, 310 may be provided to identify the migration status of the user data 302. Examples of the flags include, but are not limited to, a normal operation flag 304, an eligible for transfer flag 306, a transfer completed block access flag 308, and a transfer completed allow access flag 310. However, one skilled in the art will appreciate that fewer or more flags may be associated with the users' records depending upon the number of statuses that a user may have during the migration from one system to another. These flags 304, 306, 308, 310 may be used to facilitate the migration of user data from one network-based system to another network-based system either all at once or over a period of time.

For example, in some instances, a company, organization, or other group of users associated with one another may have only a few users and thus all of the user data may be migrated at once in a short period of time, e.g., in a matter of seconds, minutes or few hours.

In other instances, the number of users in a company or organization may make require several hours or even a few days to migrate all of the user data from one system to a second system, during which time each of the users may not be able to access the system. In these instances, the user data associated with a predetermined number or group of users may be transferred incrementally over a period of time, during which the users may be granted access to some services and denied access to others.

For example, a credit card issuer (e.g., a bank) may provide its customers with access to their accounts via the Internet. Customers may access their accounts by going to a website and entering their usernames and passwords, after which, they are directed to a web interface where they are provided with information concerning their account. If, for example, the issuer is acquired by another entity, then the acquiring entity may want to migrate the user data from the acquired issuers' database to its own database. Due to the large number of customers an issuer may have, the acquiring entity may choose to designate that all customers with a VISA credit card will be migrated during one month, and customers with another type of financial instrument (e.g., a debit card) will be migrated in another month.

Alternatively, a corporation may provide its employees with access to a network-based application via an intranet. If the corporation changes from one network-based application to another network-based application, then it may need to migrate the employee records from the old application to the new application. Accordingly, the corporation may choose to transfer the employee/user data associated with each person in the sales department from one system to another on one day, and then data associated with the shipping department on the next. One skilled in the art will appreciate that other implementations as well as other divisions, sub-groups, or categorical designations of users may be identified.

Once the group of users is identified as being ready for transfer from the old system to the new system, an eligible for transfer flag 306 is set in the user data 302 stored in database 300. If the eligible for transfer flag 306 is set, then the next time the user logs into the current system by entering his/her username and password, the migration from the current system to the new system will be performed.

The migration may be initiated in a variety of ways. For example, after successfully logging into the current system, the user may be redirected to a change password menu where the user must enter a new password. This new password will be stored by the user as the password for the new system. Additionally, the user data will be migrated to the new system upon successfully entering the new password. In an alternative scenario, upon successfully logging into the current system, the user may be emailed or otherwise sent a secure URL or link that, when selected or entered into a browser, directs the user to a new password registration menu for the new service. Once the user successfully changes his/her password, then the user's data is migrated to the new system.

If a user is not yet designated to be migrated from the current system to a new system, then the normal operation flag 304 associated with the user data 302 may be set and stored in database 300. With the normal operation flag 304 set, the next time the user logs into the system the system will detect the normal operation flag 304 and the user will be logged into the current system in the normal manner.

The migration of the data may be accomplished by a server of the current system establishing a connection with a server of the new system, and then copying the data from one server to another via the For example, the connection between the two servers may be via the Internet 104 and the data may then be transmitted in accordance with Transfer Control Protocol (TCP), TCP/IP, and the like, from the first server to the second server. Alternatively, the data may be transmitted from one server to another server via the network using a communication protocol such as Internet Protocol (IP), User Datagram Protocol (UPD), and the like.

The transfer completed allow access flag 310, when set, enables a user to gain access to historical data stored in the old system by directly accessing the old system even after the user's data have been migrated to the new system. However, the transfer completed allow access flag prevents the re-transfer of the user's information from the old system to the new system. If a user attempts to gain access to the old system, an access denied message may be displayed or the user may be redirected to the new service.

The transfer completed block access flag 308, when set, prevents a user from being able to access the old system once the user has been copied to the new system. In one embodiment, both the transfer completed allow access flag 310 and transfer completed block access flag 308 may be set as soon as the user successfully logs into the current system and the data is migrated. In an alternative embodiment, the transfer completed flags 308 and 310 may be set by the new system sending a message to the old system when a user successfully changes his/her password.

In some embodiments, users may be required to register with the new service if they do not go through the migration process within a predetermined amount of time. For example, a user may be notified by way of email, text message, or other manner of notification that he/she has two weeks in which to log into the current system so that the migration process may be performed. If the user does not log into the current system within the predetermined time period, then the user's information will not be migrated to the new system, and in order to gain access to the new system, the user would be required to register with the new system. Terminating a user account and requiring a user to register with the new service removes user accounts that were created by users who no longer use the system and reduces the amount of data that is transferred to the new system.

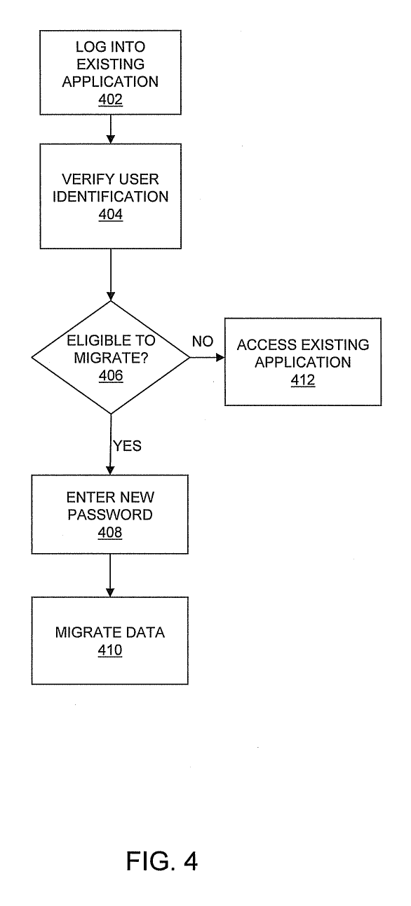

FIG. 4 illustrates one example of a flow diagram of a method of migration in accordance with the present disclosure. As shown in FIG. 4, a user logs into an existing application at block 402. The existing application verifies the user identification at block 404, which may be accomplished by comparing a username and password entered by a user with a username and password stored in a database.

At decision block 406, the existing system determines if the user has been designated as, and is eligible to, migrate to the new application. The existing system may determine if the user is eligible to be transferred by checking to see which flag 304, 306, 308, or 310 is set in the user data 302 stored in database 300.

If the eligible for transfer flag 306 is set, then at block 408 the user may be directly transferred to an interface to enter a new password for the new system, or the user may be sent a secured link via email or another electronic message that, when clicked by the user, takes the user to the password entry interface. At block 410, the server 200 of the current system establishes a connection with the server of the new system and transfers the user data.

At block 412, if the eligible for transfer flag 306 is not set and the normal operation flag 304 is set, then the user is given access to the current system and the user's data is not transferred.

In addition to the above described embodiments, the disclosed method and system may be embodied in the form of computer-implemented processes and apparatus for practicing those processes. The present disclosed method and apparatus may also be embodied in the form of computer program code embodied in tangible storage media, such as floppy diskettes, read only memories (ROMs), CD-ROMs, hard drives, “ZIP™” high density disk drives, DVD-ROMs, flash memory drives, or any other computer-readable storage medium, wherein, when the computer program code is loaded into and executed by a computer, the computer becomes an apparatus for practicing the disclosed method and system. The present disclosed method and apparatus may also be embodied in the form of computer program code, for example, whether stored in a storage medium, loaded into and/or executed by a computer, wherein, when the computer program code is loaded into and executed by a computer, the computer becomes a special-purpose apparatus for practicing the disclosed method. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of transferring a user record from a first system to a second system, comprising:
determining whether a user record is eligible for migration from the first system to the second system;
transferring the user record from the first system to the second system; and
flagging the user record in the first system as having been transferred.

2. The method of claim 1, wherein flagging the user record as transferred includes setting a flag associated with the user record that identifies the user record as transferred.

3. The method of claim 2, wherein setting the flag associated with the user record prevents a user from accessing the first system.

4. The method of claim 1, wherein determining the user record as eligible for migration includes identifying one of a plurality of flags associated with the user record as set.

5. The method of claim 1, further comprising:
comparing login data received from a login portal to login data stored in a database;
granting access to the first system if the received login data matches the stored login data; and
denying access to the first system if the received login data does not match the stored login data.

6. The method of claim 1, further comprising:
receiving a message from the second system, the message identifying that the user has successfully registered with the second system.

7. The method of claim 5, further comprising:
providing a secure link to the second system after granting access to the first system.

8. A method, comprising:
identifying data associated with a plurality of users stored in a database as eligible for migration from a first network-based system to a second network-based system;
migrating the data from the first network-based system to the second network-based system, the migration of data including: and
transferring data from the first network-based system to the second network-based system; and
setting an indicator in the data associated with each of the plurality of users that the data was transferred.

9. The method of claim 8, wherein the indicator is set after receiving a message from the second system.

10. The method of claim 8, wherein the data is identified as eligible for migration if one of a plurality flags is set.

11. The method of claim 8, further comprising:
comparing login data received from a login portal to login data stored in a database;
granting access to the first system if the received login data matches the stored login data; and
denying access to the first system if the received login data does not match the stored login data.

12. The method of claim 8, wherein the indicator is a flag that prevents data from being migrated a second time.

13. The method of claim 12, wherein the indicator further prevents a user to access the first network-based system.

14. The method of claim 8, wherein the plurality of users is a sub-set of a larger group of users.

15. A machine readable storage medium encoded program code, wherein when the program code is executed by a processor, the processor performs a method comprising the steps of:
determining whether a user record is eligible for migration from a first system to a second system;
transferring the user record from the first system to the second system; and
flagging the user record as having been transferred in the first system by setting a flag in a database.

16. The machine readable storage medium of claim 15, wherein setting the flag associated with the user record prevents a user from accessing the first system.

17. The machine readable storage medium of claim 15, wherein determining the user record as eligible for migration includes identifying one of a plurality of flags associated with the user record as set.

18. The machine readable storage medium of claim 15, further comprising:
comparing login data received from a login portal to login data stored in a database.

19. The machine readable storage medium of claim 15, further comprising:
receiving a message from the second system, the message identifying that the user has successfully registered with the second system.

20. A system comprising:
a processor;
a first database connected to the processor, the first database including at least one stored user data record, the user data record including a status flag;
a communication interface connected to the processor and the first database, the communication interface configured to transmit the at least one stored user data record from the first database to a second database,
wherein the communication interface is configured to transmit the at least one stored user data record from the first database to the second database in response to receiving a signal from the second database and the processor determining that the at least one data record is eligible for transmission.

21. The system of claim 20, wherein the communication interface is connected to a network.

22. The system of claim 20, wherein the status flag identifies that the at least one user data record is eligible for transmission.

23. The system of claim 20, wherein the status flag identifies that the at least one user data record is not eligible for transmission.

24. The system of claim 20, wherein the at least one user data record includes a plurality of status flags.

25. The system of claim 20, wherein the communication interface is configured to transmit the at least one stored user data record to the second database using Transfer Control Protocol (TCP).
